(19) United States
(12) Patent Application Publication
(10) Pub. No.: US 2009/0240005 A1
(43) Pub. Date: Sep. 24, 2009

(54) DISPERSION ADHESIVES

(75) Inventors: Harald Kraus, Leverkusen (DE); Wolfgang Henning, Kuerten (DE); Wolfgang Arndt, Dormagen (DE); Erkut Ilter, Ditzingen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/370,786

(22) Filed: Feb. 13, 2009

(30) Foreign Application Priority Data
Feb. 15, 2008 (DE) 102008009517.6

(51) Int. Cl. C08G 71/04

(52) U.S. Cl. 525/458; 525/457

(57) ABSTRACT

The invention relates to aqueous dispersion adhesives based on a mixture of aqueous polyurethane or polyurethane-urea dispersions, to a process for their preparation, and to the use of the dispersion adhesives in the production of adhesive composites.

### RELATED APPLICATIONS

This application claims benefit to German Patent Application No. 10 2008 009 517.6, filed Feb. 15, 2008, which is incorporated herein by reference in its entirety for all useful purposes.

### BACKGROUND OF THE INVENTION

The invention relates to aqueous dispersion adhesives based on a mixture of aqueous polyurethane or polyurethane-urea dispersions, to a process for their preparation, and to the use of the dispersion adhesives in the production of adhesive composites.

Adhesives based on aqueous polyurethane dispersions have become established worldwide in demanding industrial applications, for example in the manufacture of shoes, the adhesive bonding of parts for the interior fitting of motor vehicles, the lamination of films or the bonding of textile substrates. The preparation of aqueous polyurethane or polyurethane-polyurea dispersions is known.

When such dispersions are used for the bonding of substrates, the heat activation process is frequently employed. In that process, the dispersion is applied to the substrate and, when the water has completely evaporated, the adhesive layer is activated by heating, for example by means of an infra-red radiator, and brought into a sticky state. The temperature at which the adhesive film becomes tacky is referred to as the activation temperature.

Adhesives based on aqueous polyurethane or polyurethane-polyurea dispersions, which are suitable for application of the heat activation process, are described in U.S. Pat. No. 4,870,129. According to that specification, aqueous polyurethane or polyurethane-polyurea dispersions can be obtained according to the acetone process using specific mixtures of diisocyanates, and the films obtainable therefrom can readily be activated.

However, when using polyurethane or polyurethane-polyurea derivatives it is also possible to employ the process of wet bonding, that is to say bonding is carried out immediately after the adhesive has been applied. Mechanical fixing of the parts to be joined is required until the adhesive has set. This process is frequently used for the bonding of wood or textile substrates.

Mixtures of polyurethane dispersions are also known. For example, U.S. Pat. No. 6,797,764 describes mixtures of specific polyester-based polyurethane dispersions having sulfonate groups and aqueous aliphatic polyurethane dispersions. They exhibit good adhesion to a large number of metal and plastics substrates by the heat activation process.

The object of the present invention was to provide dispersion adhesives which exhibit excellent bonding properties both by the heat activation process and by the process of wet bonding.

Surprisingly, it has now been found that the mixtures of aqueous polyurethane or polyurethane-polyurea dispersions described hereinbelow are suitable as adhesives both by the heat activation process and by the process of wet bonding and exhibit bonding strengths that are better than those of the individual components.

### Embodiments of the Invention

An embodiment of the present invention is an aqueous dispersion comprising a mixture of
A) an aqueous polyurethane or polyurethane-urea dispersion comprising
   I. a polymer A) composed of
      I(i) at least one difunctional aliphatic polyester polyol having a molecular weight of from 400 to 5000 g/mol;
      I(ii) at least one mixture of hexamethylene diisocyanate (HDI) and 1-isocyanato-3,3,5-trimethyl-5-isocyanatomethyl-cyclohexane (IPDI); and
      I(iii) at least one mixture of two or more aminic chain extenders, wherein at least one aminic chain extenders has an ionic group;
   wherein said polymer A) is semi-crystalline or crystalline after drying and has a glass transition at a glass transition temperature Tg of from −65° C. to −40° C.;
B) an aqueous polyurethane or polyurethane-urea dispersion other than A) comprising
   II. a polymer B) composed of
      II(i) at least one difunctional aromatic polyester polyol having a molecular weight of from 400 to 5000 g/mol;
      II(ii) at least one difunctional polyol having a molecular weight of from 62 to 399;
      II(iii) at least one aliphatic diisocyanate; and
      II(iv) at least one aminic chain extender having an ionic group;
      wherein said polymer B) is amorphous after drying and has a glass transition at a glass transition temperature Tg of from −15° C. to +10° C.

Another embodiment of the present invention is the above aqueous dispersion, wherein A) is present in an amount of from 30 to 90 weight % and B) is present in an amount of from 10 to 70 weight % based on the total weight of A) and B).

Another embodiment of the present invention is the above aqueous dispersion, wherein the molar ratio of HDI to IPDI is in the range of from 9:1 to 1:9.

Another embodiment of the present invention is the above aqueous dispersion, wherein I(iii) is a mixture of 1,2-ethanediamine and the sodium salt of N-(2-aminoethyl)-2-aminoethanesulfonic acid.

Another embodiment of the present invention is the above aqueous dispersion, wherein the 1,2-ethanediamine and the sodium salt of N-(2-aminoethyl)-2-aminoethanesulfonic acid in said mixture has a molar ratio in the range of from 6:1 to 1:6.

Another embodiment of the present invention is the above aqueous dispersion, wherein II(i) is a polyester polyol based on o-phthalic acid and/or o-phthalic anhydride and 1,4-butanediol and/or 1,6-hexanediol.

Yet another embodiment of the present invention is a process for preparing the above aqueous dispersion, comprising mixing A) and B) with one another.

Yet another embodiment of the present invention is an adhesive composition comprising the above aqueous dispersion.

Yet another embodiment of the present invention is a two-component adhesive composition comprising the above aqueous dispersion and at least one polyisocyanate compound having at least two isocyanate groups per molecule.

Yet another embodiment of the present invention is an adhesive composite comprising a substrate and/or a sheet-like structure bonded with the above aqueous dispersion.

### DESCRIPTION OF THE INVENTION

The present invention accordingly provides aqueous dispersions comprising a mixture of

A) an aqueous polyurethane or polyurethane-urea dispersion containing
I a polymer A) composed of
   I(iv) at least one difunctional aliphatic polyester polyol having a molecular weight of from 400 to 5000 g/mol,
   I(v) at least one mixture of hexamethylene diisocyanate (HDI) and 1-isocyanato-3,3,5-trimethyl-5-isocyanatomethyl-cyclohexane (IPDI) and
   I(vi) at least one mixture of two or more aminic chain extenders, at least one compound carrying an ionic group,
wherein the polymer A) is semi-crystalline or crystalline after drying, with a glass transition at a glass transition temperature Tg of from −65° C. to −40° C.,
   B) an aqueous polyurethane or polyurethane-urea dispersion other than A), containing
II. a polymer B) composed of
   II(i) at least one difunctional aromatic polyester polyol having a molecular weight of from 400 to 5000 g/mol,
   II(ii) at least one difunctional polyol component having a molecular weight of from 62 to 399,
   II(iii) at least one aliphatic diisocyanate and
   I(Iv) at least one aminic chain extender having an ionic group,
wherein the polymer B) is amorphous after drying, with a glass transition at a glass transition temperature of from −15° C. to +10° C.

The aqueous dispersions according to the invention contain a mixture of from 30 to 90 wt. %, preferably from 45 to 75 wt. %, particularly preferably from 55 to 65 wt. %, most particularly preferably 60 wt. %, of the aqueous polyurethane or polyurethane-urea dispersion containing polymer A), and from 10 to 70 wt. %, preferably from 25 to 55 wt. %, particularly preferably from 35 to 45 wt. %, most particularly preferably 40 wt. %, of the aqueous polyurethane or polyurethane-urea dispersion containing polymer B).

There come into consideration as suitable difunctional aliphatic polyester polyols A(Ii) in particular linear polyester diols, as can be prepared in a known manner from aliphatic or cycloaliphatic dicarboxylic acids, such as, for example, succinic acid, methylsuccinic acid, glutaric acid, adipic acid, pimelic acid, suberic acid, azelaic acid, sebacic acid, nonanedicarboxylic acid, decanedicarboxylic acid, tetrahydrophthalic acid, hexahydrophthalic acid, cyclohexanedicarboxylic acid, maleic acid, fumaric acid, malonic acid or mixtures thereof, with polyhydric alcohols, such as, for example, ethanediol, di-, tri-, tetra-ethylene glycol, 1,2-propanediol, di-, tri-, tetra-propylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol or mixtures thereof. Instead of the free carboxylic acid it is possible to use for the preparation of the polyesters also the corresponding polycarboxylic acid anhydrides or corresponding polycarboxylic acids of low alcohols or mixtures thereof.

Preference is given to difunctional aliphatic polyester polyols A(Ii) based on succinic acid, methylsuccinic acid, glutaric acid, adipic acid or maleic acid and 1,3-propanediol, 1,4-butanediol or 1,6-hexanediol.

Particular preference is given to difunctional aliphatic polyester polyols A(Ii) based on adipic acid and 1,4-butanediol or 1,6-hexanediol.

Most particular preference is given to difunctional aliphatic polyester polyols A(Ii) based on adipic acid and 1,4-butanediol.

The molecular weight of the difanctional aliphatic polyester polyol A(Ii) is from 400 to 5000 g/mol, preferably from 1500 to 3000 g/mol, particularly preferably from 1900 to 2500 g/mol, most particularly preferably from 2100 to 2300 g/mol.

As isocyanate component A(Iii) there is used a mixture of hexamethylene diisocyanate (HDI) and 1-isocyanato-3,3,5-trimethyl-5-isocyanatomethyl-cyclohexane (IDPI). The molar ratio HDI:IPDI is preferably from 9:1 to 1:9, particularly preferably from 3:1 to 1:3, most particularly preferably 2:1.

Component A(Iiii) consists of a mixture of two or more aminic chain extenders, at least one compound carrying an ionic group. Chain extenders within the scope of the invention are also understood as being monoamines that result in chain termination.

Examples of monoamines are aliphatic and/or alicyclic primary and/or secondary monoamines, such as ethylamine, diethylamine, the isomeric propyl- and butyl-amines, higher linear-aliphatic monoamines and cycloaliphatic monoamines, such as cyclohexylamine. Further examples are amino alcohols, that is to say compounds that contain amino and hydroxyl groups in one molecule, such as, for example, ethanolamine, N-methylethanolamine, diethanolamine or 2-propanolamine. Further examples are monoamino compounds which additionally carry sulfonic acid and/or carboxyl groups, such as, for example, taurine, glycine or alanine.

Examples of diamino compounds are 1,2-ethanediamine, 1,6-hexamethylenediamine, 1-amino-3,3,5-trimethyl-5-aminomethyl-cyclohexane (isophoronediamine), piperazine, 1,4-diaminocyclohexane or bis-(4-aminocyclohexyl)-methane. Also suitable are adipic acid dihydrazide, hydrazine and hydrazine hydrate. It is also possible to use polyamines, such as diethylenetriamine, as chain-extension component instead of a diamino compound.

Further examples are amino alcohols, that is to say compounds that contain amino and hydroxyl groups in one molecule, such as, for example, 1,3-diamino-2-propanol, N-(2-hydroxyethyl)-ethylenediamine or N,N-bis(2-hydroxyethyl)-ethylenediamine.

Examples of diamino compounds which have an ionic group, that is to say which additionally carry sulfonate and/or carboxylate groups, are the sodium or potassium salts of N-(2-aminoethyl)-2-aminoethanesulfonic acid/carboxylic acid, of N-(3-aminopropyl)-2-aminoethanesulfonic acid/carboxylic acid, of N-(3-aminopropyl)-3-aminopropanesulfonic acid/carboxylic acid or of N-(2-aminoethyl)-3-aminopropanesulfonic acid/carboxylic acid. Preference is given to the sodium salt of N-(2-aminoethyl)-2-aminoethanesulfonic acid.

Preferred constituents of the mixture A(Iiii) are diethanolamine, 1,2-ethanediamine, 1-amino-3,3,5-trimethyl-5-aminomethyl-cyclohexane (isophoronediamine), piperazine, N-(2-hydroxyethyl)-ethylenediamine and the sodium salts of N-(2-aminoethyl)-2-aminoethanesulfonic acid/carboxylic acid.

Particular preference is given to a mixture of 1,2-ethanediamine and the sodium salt of N-(2-aminoethyl)-2-aminoethanesulfonic acid. This mixture is preferably used in a molar ratio of from 6:1 to 1:6, particularly preferably in a molar ratio of from 2:1 to 1:4, most particularly preferably in a molar ratio of from 1:3 to 1:4.

The polymer A) is semi-crystalline or crystalline after drying, with a glass transition at a glass transition temperature Tg of from −65° C. to −40° C., preferably with a Tg from −60° C. to −45° C., particularly preferably from −55° C. to −50° C.

There come into consideration as suitable difunctional aromatic polyester polyols B(IIi) in particular linear polyester diols as can be prepared in a known manner from aromatic dicarboxylic acids, such as, for example, terephthalic acid, isophthalic acid or o-phthalic acid and the acid anhydrides thereof, such as, for example, o-phthalic anhydride, and polyhydric alcohols, such as, for example, ethanediol, di-, tri-, tetra-ethylene glycol, 1,2-propanediol, di-, tri-, tetra-propylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol or mixtures thereof.

Preference is given to difunctional aromatic polyester polyols B(IIi) based on o-phthalic acid, o-phthalic anhydride and 1,4-butanediol or 1,6-hexanediol.

Particular preference is given to difunctional aromatic polyester polyols B(IIi) based on o-phthalic acid or o-phthalic anhydride and 1,6-hexanediol.

The molecular weight of the difunctional aromatic polyester polyol B(IIi) is from 400 to 5000 gμmol, preferably from 1500 to 3000 g/mol, particularly preferably from 1800 to 2300 g/mol, most particularly preferably from 1900 to 2100 g/mol.

Difunctional polyol components having a molecular weight of from 62 to 399 that are suitable as chain-extension component B(IIii) are, for example, the products listed under A(Ii) and B(IIi), provided they have a molecular weight of from 62 to 399 daltons. Further suitable components are the polyhydric, in particular dihydric, alcohols mentioned for the preparation of the polyester polyols, and also low molecular weight polyester diols, such as, for example, adipic acid bis-(hydroxyethyl) ester. Short-chained difunctional polyether polyols, such as, for example, the homopolymers, mixed polymers and graft polymers of ethylene oxide or propylene oxide, are also suitable.

Preferred chain-extension components B(IIii) are 1,4-butanediol and 1,6-hexanediol, with 1,6-hexanediol being particularly preferred.

Suitable as chain-extension components B(IIiii) are any desired aliphatic compounds that contain at least two free isocyanate groups per molecule. Preference is given to diisocyanates Y(NCO)₂, wherein Y represents a divalent aliphatic hydrocarbon radical having from 4 to 12 carbon atoms or a divalent cycloaliphatic hydrocarbon radical having from 6 to 15 carbon atoms. Examples of such diisocyanates which are preferably to be used are tetramethylene diisocyanate, methylpentamethylene diisocyanate, hexamethylene diisocyanate, dodecamethylene diisocyanate, 1,4-diisocyanato-cyclohexane, 1-isocyanato-3,3,5-trimethyl-5-isocyanatomethyl-cyclohexane, 4,4′-diiso-cyanato-dicyclohexyl-methane or 4,4′-diisocyanato-2,2 dicyclohexylpropane or mixtures thereof.

Particular preference is given to hexamethylene diisocyanate (HDI), 1-isocyanato-3,3,5-trimethyl-5-isocyanatomethyl-cyclohexane (IPDI) and 4,4′-diisocyanato-dicyclohexyl-methane and mixtures thereof. However, it is preferred to use the isocyanates on their own.

Most particular preference is given to hexamethylene diisocyanate (HDI).

Aminic chain extenders B(IIiv) having an ionic group are preferably diamino compounds which additionally carry sulfonate and/or carboxylate groups, such as, for example, the sodium or potassium salts of N-(2-aminoethyl)-2-aminoethanesulfonic acid, of N-(3-aminopropyl)-2-aminoethanesulfonic acid, of N-(3-aminopropyl)-3-aminopropanesulfonic acid, of N-(2-aminoethyl)-3-aminopropanesulfonic acid or of the analogous carboxylic acids.

Particular preference is given to the sodium salts of N-(2-aminoethyl)-2-aminoethanesulfonic acid and the analogous carboxylic acids; the sodium salt of N-(2-aminoethyl)-2-aminoethanesulfonic acid is most particularly preferred.

The aminic chain extenders B(IIiv) having an ionic group can be used on their own or together with other aminic chain extenders as have been described, for example, under A(Iiii). They are preferably used on their own.

After drying, the polymer B) is amorphous, with a glass transition at a glass transition temperature Tg of from −15° C. to +10° C., preferably with a Tg from −10° C. to +5° C., particularly preferably from −5° C. to 0° C.

The aqueous polyurethane or polyurethane-urea dispersion containing the polymer A) or B) has a solids content of from 10 to 70 wt. %, preferably from 25 to 60 wt. % and particularly preferably from 35 to 55 wt. %.

The polymers A) or B) present in the aqueous polyurethane or polyurethane-urea dispersions are preferably prepared by the acetone process. To that end, prepolymers are prepared from components A(Ii) and A(Iii) or B(IIi), B(IIii) and B(IIiii), dissolved in acetone and chain-extended with components A(Iiii) or B(IIiv). After dispersion with water, the acetone is distilled off. The application and implementation of the acetone process is prior art and known to the person skilled in the art.

The present invention further provides a process for the preparation of the dispersions according to the invention, which process is characterised in that the aqueous polyurethane or polyurethane-urea dispersions of polymers A) and B) are mixed with one another.

The bonds produced with the dispersions according to the invention exhibit good peel strengths of >4 N/mm², preferably >4.2 N/mm², particularly preferably >4.5 N/mm², after 3 days in the case of the one-component bonding of beech-wood substrates by the process of wet bonding. In the case of the one-component bonding of a rigid PVC film to beech wood by the heat activation process at a heat activation temperature of 100° C., peel strengths of >3.4 N/mm², preferably >3.5 N/mm², particularly preferably >3.6 N/mm², are obtained after 3 days. One-component within the scope of the invention means without the use of an additional crosslinker component such as, for example, isocyanates or carbodiimides. The dispersion adhesives according to the invention are, however, also suitable in principle for applications with the addition of a crosslinker component.

The present invention also provides the use of the aqueous dispersions according to the invention in the preparation of adhesive compositions.

The adhesive compositions comprising the dispersions according to the invention can be used on their own or together with binders, auxiliary substances and additives known in coatings and adhesives technology, in particular emulsifiers and light stabilisers, such as UV absorbers and sterically hindered amines (HALS), also antioxidants, fillers and auxiliary agents, for example antisettling agents, antifoams and/or wetting agents, flow improvers, reactive diluents, plasticisers, catalysts, auxiliary solvents and/or thickeners and additives such as, for example, pigments, colourings or mattifying agents. Tackifiers can also be added.

The additives can be added to the dispersions according to the invention immediately before processing. However, it is also possible to add at least some of the additives before or during the dispersion of the binder.

The choice and metered addition of these substances, which can be added to the individual components and/or to the mixture as a whole, are known in principle to the person skilled in the art and can, without an unduly high outlay, tailored to the specific application, be determined by simple preliminary tests.

The present invention also provides two-component (2K) adhesive compositions comprising the dispersions according to the invention and at least one polyisocyanate compound having at least two isocyanate groups per molecule. The polyisocyanate is added prior to use (2K processing). Preference is given in this case to the use of polyisocyanate compounds that are emulsifiable in water. These are, for example, the compounds described in EP-A 0 206 059, DE-A 31 12 117 or DE-A 100 24 624. The polyisocyanate compounds are used in an amount of from 0.1 to 20 wt. %, preferably from 0.5 to 11 wt %, particularly preferably from 1.5 to 6 wt. %, based on the aqueous dispersion.

The dispersions according to the invention are used in particular to prepare adhesive compositions that are suitable for the production of adhesive composites, wherein the adhesive composite comprises a substrate, the dispersion according to the invention and a sheet-like structure. The substrate and the sheet-like structure can be made of the same or of different materials.

The dispersions according to the invention are distinguished by excellent adhesion to a very wide variety of substrates and sheet-like structures, such as, for example, wood, paper, leather, textiles, cork, plastics such as various grades of polyvinyl chloride, polyurethanes, polyvinyl acetate, rubbers, polyethylvinyl acetate, glass fibres, woven and knitted fabrics of glass fibres, carbon fibres and mineral fibres, and also mineral materials such as stone, concrete, gypsum or plaster.

The adhesive compositions comprising the dispersions according to the invention are accordingly suitable for bonding any desired substrates and sheet-like structures, preferably made of the above-mentioned materials.

The adhesives according to the invention are particularly suitable for bonding substrates and sheet-like structures made of wood.

They are also suitable for bonding soles based on polyvinyl chloride, in particular plasticised polyvinyl chloride, or on polyethylvinyl acetate or polyurethane elastomeric foam, to shoe shafts made of leather or synthetic leather and for bonding films based on polyvinyl chloride or plasticised polyvinyl chloride to wood.

The adhesive compositions comprising the dispersions according to the invention are also suitable for bonding woven composites and knitted fabrics of glass fibres, carbon fibres or mineral fibres to mineral substrates, for example, such as stone, concrete, gypsum or plaster. It is thereby possible, for example, better to protect buildings or structures from damage by mechanical influences or vibrations, such as, for example, earthquakes. This use is particularly preferred.

The present application likewise provides an adhesive composite comprising substrates and sheet-like structures bonded by means of the dispersions according to the invention.

The adhesives according to the invention are processed by the known methods of adhesives technology in respect of the processing of aqueous dispersion adhesives.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

The invention is explained in detail hereinbelow by means of the examples. The peel strengths after application of the process of wet bonding and of the heat activation process can be determined by the following methods:

A) Determination of the peel strength after application of the process of wet bonding

The determination is carried out in one-component form (without a crosslinker).

### Test Material/Test Specimen

Beech wood (planed)/beech wood (planed), dimensions: 40×20×5 mm

### Bonding and Measurement

The adhesive dispersion is applied by means of a brush to both beech-wood test specimens. The bonding area is 10×20 mm. The two test specimens are then placed one above the other and joined for 72 hours at room temperature and a pressure of 5 bar.

A load is then applied to the test specimens, at room temperature, at an angle of 180° to the joint, and the test specimens are pulled apart at a rate of 100 mm per minute. The force required therefor (=peel strength, tensile-shear strength) is measured. A determination is carried out in quintuplicate and the average value is indicated.

B) Determination of the peel strength after application of the heat activation process

1K bonding: adhesive without crosslinker

### Test Material/Test Specimen

a) Beech wood (planed)

Dimensions: 30×210×4.0 mm

b) Rigid PVC laminating film (Benelit RTF; Benecke-Kaliko AG, Hanover/D)

Dimensions: 30×210×0.4 mm

### Bonding and Measurement

The adhesive dispersion is applied by means of a brush to the beech-wood test specimens. The bonding area is 30×90 mm. After a drying time of 30 minutes at room temperature, a second adhesive layer is applied over the first and the test specimens are then dried for 60 minutes at room temperature. The two test specimens are then placed one above the other and joined for 10 seconds at 100° C. and a pressure of 4 bar.

After the test specimens have been stored for three days at room temperature, the PVC film is pulled off at an angle of 180° C. to the joint, at a rate of 30 mm per minute, and the force required therefor (=peel strength) is measured. A determination is carried out in duplicate and the average value is indicated.

C) The glass transition temperatures were determined by means of differential scanning calorimetry (DSC) using a Pyris Diamond DSC calorimeter from Perkin-Elmer. To that end, a film was prepared on a glass plate by applying the dispersion by means of a coating knife in a wet film thickness of 100 μm, and the glass plate was stored in a dry box for 3 days at room temperature and 0% ambient humidity. The DSC curve was then recorded using 10 mg of sample material, under the following measuring conditions: Rapid cooling to the starting temperature of −100° C., then the start of three heating operations from −100° C. to +150° C. at a rate of heating of 20 K/minute and a rate of cooling of 320 K/minute, under a helium atmosphere and with cooling by means of liquid nitrogen. The glass transition temperature corresponds to the temperature at the half-height of the glass transition.

### Materials Used

Dispersion I: VP KA 8481 (Bayer MaterialScience AG, Leverkusen/D) Sulfonate-stabilised polyurethane dispersion based on an adipic acid/butanediol polyester and a mixture of hexamethylene diisocyanate (HDI) and isophorone diisocyanate (IPDI) (solids content of the dispersion about 40%). The resulting polymer is semi-crystalline after drying, with a glass transition at a glass transition temperature Tg of −52.5° C.
Dispersion II: Dispercoll® U42 (Bayer MateriaiScience AG, Leverkusen/D) Sulfonate-stabilised polyurethane dispersion based on a phthalic anhydride/hexanediol polyester, hexanediol and hexamethylene diisocyanate (solids content of the dispersion about 50%). The resulting polymer is amorphous after drying, with a glass transition at a glass transition temperature Tg of −3.5° C.

### Example 1

### According to the Invention

To 600 g of the VP KA 8481 dispersion there are added slowly, with stirring, 400 g of the Dispercoll® U 42 dispersion, and stirring is carried out until a homogeneous mixture forms. Corresponding test specimens are then prepared using the heat activation process and the process of wet bonding, and the peel strengths are determined (for description see above).

### Example 2

### Comparison

Using VP KA 8481, corresponding test specimens are prepared using the heat activation process and the process of wet bonding, and the peel strengths are determined (for description see above).

### Example 3

### Comparison

Using Dispercoll® U 42, corresponding test specimens are prepared using the heat activation process and the process of wet bonding, and the peel strengths are determined (for description see above).

TABLE 1

| | Example 1 | | Example 3 |
|---|---|---|---|
| | (according to | Example 2 | (comparison) |
| | the invention) | (comparison) | Dispercoll ® |
| | Mixture | VP KA 8481 | U42 |
| Peel resistance after | 4.8 | 3.4 | 4.1 |
| 3 d [N/mm] | | | |
| beech wood/beech wood | | | |
| wet bonding process | | | |
| Peel resistance after | 3.9 | 3.4 | 3.5 |
| 3 d [N/mm] | | | |
| beech wood/rigid PVC film | | | |
| heat activation process | | | |

1. An aqueous dispersion comprising a mixture of
A) an aqueous polyurethane or polyurethane-urea dispersion comprising
II. a polymer A) composed of
I(i) at least one difunctional aliphatic polyester polyol having a molecular weight of from 400 to 5000 g/mol;
I(ii) at least one mixture of hexamethylene diisocyanate (HDI) and 1-isocyanato-3,3,5-trimethyl-5-isocyanatomethyl-cyclohexane (IPDI); and
I(iii) at least one mixture of two or more aminic chain extenders, wherein at least one aminic chain extenders has an ionic group;
wherein said polymer A) is semi-crystalline or crystalline after drying and has a glass transition at a glass transition temperature Tg of from −65° C. to −40° C.;
B) an aqueous polyurethane or polyurethane-urea dispersion other than A) comprising
II. a polymer B) composed of
II(i) at least one difunctional aromatic polyester polyol having a molecular weight of from 400 to 5000 g/mol;
II(ii) at least one difunctional polyol having a molecular weight of from 62 to 399;
II(iii) at least one aliphatic diisocyanate; and
II(iv) at least one aminic chain extender having an ionic group;
wherein said polymer B) is amorphous after drying and has a glass transition at a glass transition temperature Tg of from −15° C. to +10° C.

2. The aqueous dispersion of claim 1, wherein A) is present in an amount of from 30 to 90 weight % and B) is present in an amount of from 10 to 70 weight % based on the total weight of A) and B).

3. The aqueous dispersion of claim 1, wherein the molar ratio of HDI to IPDI is in the range of from 9:1 to 1:9.

4. The aqueous dispersion of claim 1, wherein I(iii) is a mixture of 1,2-ethanediamine and the sodium salt of N-(2-aminoethyl)-2-aminoethanesulfonic acid.

5. The aqueous dispersion of claim 4, wherein the 1,2-ethanediamine and the sodium salt of N-(2-aminoethyl)-2-aminoethanesulfonic acid in said mixture has a molar ratio in the range of from 6:1 to 1:6.

6. The aqueous dispersion of claim 1, wherein II(i) is a polyester polyol based on o-phthalic acid and/or o-phthalic anhydride and 1,4-butanediol and/or 1,6-hexanediol.

7. A process for preparing the aqueous dispersion of claim 1, comprising mixing A) and B) with one another.

8. An adhesive composition comprising the aqueous dispersion of claim 1.

9. A two-component adhesive composition comprising the aqueous dispersion of claim 1 and at least one polyisocyanate compound having at least two isocyanate groups per molecule.

10. An adhesive composite comprising a substrate and/or a sheet-like structure bonded with the aqueous dispersion of claim 1.
